(19) United States
(12) Patent Application Publication
(10) Pub. No.: US 2003/0236335 A1
(43) Pub. Date: Dec. 25, 2003

(54) Thermally-conductive plastic substrates for electronic circuits and methods of manufacturing same

(76) Inventors: James D. Miller, Marietta, GA (US); E. Mikhail Sagal, Wakefield, RI (US); Kevin A. McCullough, North Kingstown, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/436,403

(22) Filed: May 12, 2003

Related U.S. Application Data
(60) Provisional application No. 60/380,350, filed on May 13, 2002.

(51) Int. Cl. C08K 3/40; B29C 45/00; C08K 3/38; C08K 3/28

(52) U.S. Cl. 524/404; 264/328.18; 264/334

(57) ABSTRACT

A thermally-conductive plastic substrate for supporting electronic circuits is provided. The substrate has a relatively low dielectric constant and good mechanical strength. The substrate is made from a polymer composition comprising a base polymer matrix and a thermally-conductive, electrically-insulating material. The composition can comprise polyphenylene sulfide and boron nitride. The composition can further comprise a reinforcing material such as glass. The invention also encompasses methods for making such substrates.

### CROSS-REFERENCE TO RELATED APPLICATIONS

This application claims the benefit of U.S. Provisional Application 60/380,350 having a filing date of May 13, 2002, the entire contents of which are hereby incorporated by reference.

### BACKGROUND OF THE INVENTION

The present invention generally relates to substrates for electronic circuits. Particularly, the invention is directed to thermally-conductive plastic substrates made from polymer compositions comprising a base polymer matrix and a thermally-conductive, electrically-insulating material. The invention also encompasses methods for making such substrates.

Ceramic materials are commonly used as circuit substrates for supporting microelectronic circuits such as semiconductors, microprocessors, silicon chips, and the like. Circuit patterns can be printed directly on the substrate using conductive paste and a screen-printing process. In general, conventional ceramic substrates perform satisfactorily in supporting microelectronic circuits. Traditional ceramic substrates are dense, chemically stable at high temperatures and have a relatively low coefficient of thermal expansion which enhances overall reliability and performance of the substrate. In addition, known ceramic substrates have generally good electrically-insulating properties and high thermal conductivity.

Many conventional ceramic substrates for electronic circuits are manufactured using a high temperature firing process. The industry uses such materials as alumina (Al₂O₃), aluminum nitride (AlN), beryllium oxide (BeO), and beryllium nitride (Be₃N₂) with alumina being particularly preferred. In the sintering process, alumina is first mixed with an organic binder, such as polyvinyl butyral and/or acrylic acid, and then vacuum-extruded into a flat strip which is dried to a green state. Following the drying step, the green strip is machine-tooled into a desired shape for the substrate. Microelectronic circuits can be created directly on the surface of the green sheets using an electrically-conductive paste and a screen-printing process. In order to increase the density of the substrate, multiple green sheets can be stacked on top of each other and compressed together. Subsequently, the multi-layered substrate and conductive paste can be sintered at a high temperature typically in the range of 1500° to 1600° C.

For example, Mazzuchelli et al., U.S. Pat. No. 4,159,295 discloses a method for making ceramic substrates for thin and thick layer electronic circuits. The method involves preparing a homogeneous ceramic mass comprising about 44 to 88 weight percent of alumina in addition to polyvinylbutyral, polypropylene oxide-ethylene oxide block copolymers, acrylic acid, polyvalent alcohol, triethylene glycol, and water. The ceramic mass is vacuum-extruded into a relatively flat strip; dried to a green state; shaped into a desired substrate shape; and fired or sintered to form a rigid ceramic substrate.

Alumina can also be added in relatively minor amounts as fillers to compositions used for manufacturing ceramic substrates. For example, Lin et al., U.S. Pat. No. 5,242,867 discloses a composition suitable for making multilayer ceramic substrates. The Patent discloses a composition which includes: (1) 40 to 80% by weight of amorphous borosilicate glass including 60-80 wt. % of silica; 15-30 wt. % of boron oxide; 0.5-1.5 wt. % of alumina; and 0.5-3 wt. % of alkali oxides, preferably Li, Na, and K oxides; and (II) 20-60% by weight of fillers selected from the group of alumina, fosterite, quartz, fused SiO₂, mullite, cordierite, BN, AlN, and mixtures thereof. The components (I) and (II) are dispersed in a binder/plasticizer matrix in a non-aqueous solvent. The composition (slurry) is cast onto silicon-coated films to produce flexible green tapes.

Toda et al., U.S. Pat. No. 4,935,285 discloses ceramic substrates for microelectronic circuits. The Patent discloses preparing a mixture comprising 80 wt. % of mullite crystals and 20 wt. % of a binder (90 wt. % of SiO₂, 7 wt. % of Al₂O₃, and 3 wt. % of MgO). The mixture is used to prepare green sheets. Circuit patterns are formed on the green sheets using conductive pastes. In order to make electrical connections between the sheets, holes are punched through the sheets and filed with paste. The sheets are stacked on top of each other, and the laminated body is sintered to make a multi-layered circuit substrate.

Enloe et al., U.S. Pat. No. 4,920,640 discloses dense ceramic sheets suitable for electronic substrates. The sheets are prepared by hot-pressing ceramic green sheets containing ceramic powder (e.g., Al₂O₃, BeO, or AlN) and organic binder (e.g., high density polyethylene). Boron nitride sheets are placed on each side of the ceramic green sheet to form a composite. After hot-pressing the composite, the boron nitride sheets are removed.

Although conventional alumina ceramic sheets are generally effective as supporting substrates for electronic circuits, they have several drawbacks. Particularly, the alumina ceramic sheets tend to be very hard and brittle, and have a relatively high dielectric constant (about 9 to 10) which can cause propagation delay of electronic signals. Further, the process for manufacturing alumina ceramic sheets involves multiple steps including extrusion, machine tooling, pressing, and sintering, and this process can be cumbersome and costly.

In view of the foregoing problems, it would be desirable to have a thermally-conductive, plastic substrate for supporting electronic circuits. The substrate should have good mechanical strength and have a relatively low dielectric constant. Further, there is a need for a new manufacturing process which does not require machine-tooling, pressing, and sintering steps. The present invention provides such a thermally-conductive, plastic substrate and a new method for making such a substrate.

### SUMMARY OF THE INVENTION

This invention relates to thermally-conductive plastic substrates for electronic circuits and methods for making such substrates.

A thermally-conductive polymer composition is used to make the substrate. The composition generally comprises: a) 20% to 80% by weight of a polymer matrix, and b) 20% to 80% by weight of a thermally-conductive, electrically-insulating material. The polymer composition may further comprise 3% to 25% by weight of a reinforcing material. The polymer matrix can be a thermoplastic or thermosetting polymer. For example, polyphenylene sulfide can be used to form the polymer matrix. The thermally-conductive, electrically-insulating material can be any suitable material. For example, the material can be selected from the group consisting of calcium oxide, titanium oxide, silicon oxide, zinc oxide, silicon nitride, aluminum nitride, boron nitride, and mixtures thereof. The reinforcing material can be glass, inorganic minerals, or other suitable material which strengthens the polymer matrix.

In the method of the current invention, a molten polymer composition is provided, and the composition is injected into a mold. The composition is then removed from the mold to form a net-shaped, thermally-conductive substrate that can be used to support an electronic circuit.

The shaped, thermally-conductive plastic substrate has several advantageous properties and performance characteristics as described in further detail below. Preferably, the substrate has a thermal conductivity of greater than 3 W/m°K., and more preferably greater than 22W/m°K.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description taken in connection with the accompanying drawing in which:

FIG. 1 is a perspective view of a thermally-conductive plastic substrate made in accordance with the present invention.

### DETAILED DESCRIPTION OF THE PREFERRED EMBODIMENTS

The present invention relates to thermally-conductive, plastic substrates for use with electronic circuits. The substrates can support such microelectronic substrates as semiconductors, microprocessors, silicon chips, and the like. The invention also includes methods for making such substrate materials.

A polymer composition comprising a polymer matrix and thermally-conductive, electrically-insulating material is used to make the substrate.

A thermoplastic polymer selected from the group consisting of polycarbonates, polyethylene, polypropylene, acrylics, vinyls, fluorocarbons, polyamides, polyesters, polyphenylene sulfide, and liquid crystal polymers such as thermoplastic aromatic polyesters can be used to form the matrix. Polyphenylene sulfide is a particularly preferred thermoplastic polymer. Alternatively, thermosetting polymers such as elastomers, epoxies, polyimides, and acrylonitriles can be used. Suitable elastomers include, for example, styrene-butadiene copolymer, polychloroprene, nitrile rubber, butyl rubber, polysulfide rubber, ethylene-propylene terpolymers, polysiloxanes (silicones), and polyurethanes. Generally, the polymer matrix comprises about 20 to about 80% by weight of the total composition and more particularly about 40 to about 80% by weight of the composition.

In the present invention, thermally-conductive, electrically-insulating materials are added to the polymer matrix. These materials impart thermal conductivity to the non-conductive polymeric matrix and have good electrical-insulation properties. Suitable materials include, for example, calcium oxide, titanium oxide, silicon oxide, zinc oxide, silicon nitride, aluminum nitride, and boron nitride. Mixtures of such materials are also suitable. Generally, the thermally-conductive, electrically-insulating materials comprise about 20 to about 80% by weight of the total composition and more particularly about 30 to about 60% by weight of the composition. Boron nitride particles are particularly preferred for use in the present invention. However, carbon materials, such as carbon fibers and flakes, are not used in the compositions of this invention, since such materials tend to detrimentally affect the composition's electrically-insulating properties.

The thermally-conductive, electrically-insulating material can be in the form of particles, granular powder, whiskers, fibers, or any other suitable form. The particles or granules can have a variety of structures and a broad particle size distribution. For example, the particles or granules can have flake, plate, rice, strand, hexagonal, or spherical-like shapes with a particle size in the range of 0.5 to 300 microns. In some instances, the thermally-conductive material can have a relatively high aspect (length to thickness) ratio of about 10:1 or greater. For example, fibers having an aspect ratio of about 50:1 can be used. Alternatively, the thermally-conductive material can have a relatively low aspect ratio of about 5:1 or less. For example, boron nitride grains having an aspect ratio of about 4:1 can be used. Both low aspect and high aspect ratio thermally-conductive materials can be added to the polymer matrix as described in McCullough, U.S. Pat. No. 6,048,919, the disclosure of which is hereby incorporated by reference. Particularly, the compositions of this invention can contain about 25 to about 60% by weight of a thermally-conductive material having a high aspect ratio of about 10:1 or greater, and about 10 to about 25% by weight of a thermally-conductive material having a low aspect ratio of about 5:1 or less.

An optional reinforcing material can be added to the polymer matrix. The reinforcing material can be glass, inorganic minerals, or other suitable strengthening material. The reinforcing material strengthens the polymer matrix and enhances the dielectric properties of the composition. The reinforcing material, if added, constitutes about 3% to about 25% by weight of the composition. In one embodiment, the composition comprises about 30 weight % polyphenylene sulfide (PPS), about 60 weight % boron nitride particles, and about 10 weight % reinforcing chopped glass based on the weight of the composition.

The thermally-conductive material and optional reinforcing material are intimately mixed and dispersed within the non-conductive polymer matrix to form the polymer composition. If desired, the mixture may contain additives such as, for example, flame retardants, antioxidants, plasticizers, dispersing aids, and mold-releasing agents. The mixture can be prepared using techniques known in the art.

The resulting composite mixture can be shaped into the desired substrate article using any suitable molding process such as melt-extrusion, casting, or injection-molding.

In general, injection-molding involves the steps of: (a) feeding the composition into a heating chamber of a molding machine and heating the composition to form a molten composition (liquid plastic); b) injecting the molten composition into a mold cavity; c) maintaining the composition in the mold under high pressure until it cools; and d) removing the molded substrate article.

The injection-molding process is effective, because it can produce a “net-shape molded” substrate. By “net-shape molded”, it is meant that the final shape of the substrate is determined by the shape of the mold. No further processing, die-cutting, machining, or other tooling is required to produce the final shape of the substrate. In contrast, additional machine processing is often needed for shaping conventional alumina ceramic substrates, and this processing can be costly and time-consuming.

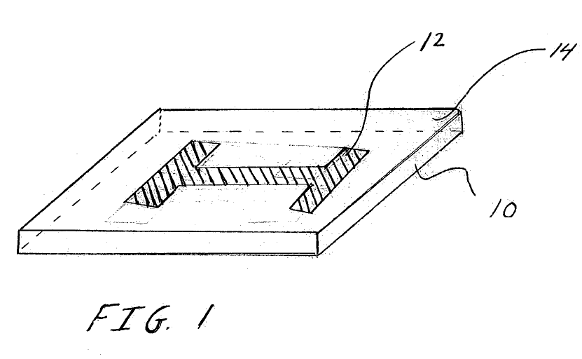

In accordance with the present invention, the thermally-conductive polymer composition can be used to prepare substrate articles as shown in FIG. 1. In FIG. 1, the substrate is generally indicated at 10. A conductive paste can be used to form electrical circuit patterns 12 on the surface 14 of the substrate 10.

The shaped, plastic substrates of the present invention have several advantageous properties. Preferably, the substrates have a thermal conductivity of greater than 3 W/m°K and more preferably greater than 22 W/m°K. These high heat conduction properties allow the finished substrate to effectively dissipate heat from heat-generating elements (for example, heat-generating printed circuits, microprocessors, silicon chips, and the like.) The substrates also have good electrical-insulation properties. For example, the substrate preferably has a volume resistivity of greater than 1.0×10¹⁶ ohms-cm and a surface resistivity of greater than 8.0×10¹⁴ ohms; a dielectric strength (breakdown voltage) of at least 44,000 (890 volts/mil) on a specimen having a thickness of about 0.05 inches; and a dielectric constant of about 4. In contrast, conventional alumina substrates have relatively high dielectric constants (about 9 to 10). Further, the plastic substrates of the present invention have good mechanical integrity and strength in contrast to alumina substrates which tend to be very hard and brittle. The various properties of plastic substrates made in accordance with the present invention versus conventional alumina substrates are described further below in the Examples.

The present invention is further illustrated by the following Examples, but these Examples should not be construed as limiting the scope of the invention.

### EXAMPLES

In the following Examples, two sample substrate materials were prepared and various electrical properties of the samples were measured. In Plastic Sample A, a thermally-conductive composition comprising about 60 weight % boron nitride particles, about 30 weight % polyphenylene sulfide (PPS), and about 10 weight % of chopped glass based on the weight of the composition was prepared and molded into a substrate. The substrate had an ivory-like colored appearance with a density of about 4 g/cc. A comparative Alumina Sample B comprising about 99% by weight alumina and about 1% by weight surfactant was prepared and molded into a substrate. The substrate had a tan/gray-like color with a density of about 1.8 g/cc. The substrate samples were evaluated and various electrical properties of the samples were measured. The test methods used to measure the electrical properties of the substrates and the measurement results are reported below.

Volume Resistivity and Surface Resistivity

The Volume Resistivity (ohms-cm) and Surface Resistivity (ohms) were measured using ASTM-D-257-99. The method involved placing each specimen individually in a Resistivity Cell connected to a High Resistance Meter. Five Hundred VDC were applied to the specimen for 60 seconds. The resistance measurements were then taken. The resistivity was calculated using the following formulas:

$$Volume Resistivity \text{:} V = \frac{19.6 \times R}{T}$$

Where,

V=Volume Resistivity (ohms-cm);

R=measured volume resistance (ohms);

T=thickness (cm); and

19.6=effective area of the guarded cell (cm²).

Surface Resistivity: S=18.8×R

Where,

S=Surface Resistivity (ohms);

R=Measured Surface Resistance (ohms); and

18.8=effective area of the guarded cell.

TABLE I

| | Volume Resistivity | Surface Resistivity |
|---|---|---|
| Sample | (ohms-cm) at 25° C. | (ohmn) at 25° C. |
| A (Plastic) | 1.7 × 10¹⁶ | 8.9 × 10¹⁵ |
| B (Alumina) | >1.0 × 10¹⁵ | 7.5 × 10¹⁴ |

Dielectric Constant and Dissipation Factor

The Dielectric Constant and Dissipation Factor were measured using ASTM-D-150-98. The thickness of each specimen was measured and recorded. Using an RF Impedance/Materials Analyzer; each specimen was placed in the testing fixture and the thickness measurement entered into the analyzer. Each specimen was allowed to stabilize and the Dielectric Constant and Dissipation Factor measurements were then taken at 1 MHz at 25° C. The frequency of the signal generator was varied around the calculated resonant frequency of the empty cavity until the output power indicated a maximum value. An attenuation was introduced at a power level 3 dB down from the resonant power level. Measurements of the resonant frequency and “Q” Quality factor were taken on the empty cavity with and without the test specimen. Test specimens were then mounted into the test cavity. The electric field inside the cavity was parallel to the length of the test specimen.

TABLE II

| Sample | Dielectric Constant | Dissipation Factor |
|---|---|---|
| A (Plastic) | 3.7 | 0.0023 |
| B (Alumina) | 9.8 | 0.0002 |

Dielectric Strength

The Dielectric Strength was measured using ASTM-D-149-97a. Electrode size (2.0″). Each specimen was immersed in Dow Corning 704 Silicone Oil. The cylindrical probes were placed in contact with the specimen. The voltage was then increased at a rate of 500 volts/second until breakdown or arc over occurred.

TABLE III

| | Breakdown | Thickness | Volts/ |
|---|---|---|---|
| Sample | Voltage | (cm) | mil |
| A (Plastic) | 44,400 | 0.02 | 890 |
| B (Alumina) | 44,000 | 0.02 | 787 |

It is appreciated by those skilled in the art that various changes and modifications can be made to the described and illustrated embodiments herein without departing from the spirit of the invention. All such modifications and changes are intended to be covered by the appended claims.

What is claimed is:

1. A method of making a net-shape molded, thermally-conductive plastic substrate for supporting electronic circuits, comprising the steps of:
a) providing a molten composition comprising i) about 20% to about 80% by weight of a polymer matrix, and ii) about 20% to about 80% by weight of a thermally-conductive, electrically-insulating material;
b) injecting the molten composition into a mold; and
c) removing the composition from the mold to form a net-shape molded, thermally-conductive substrate.

2. The method of claim 1, wherein the substrate has a thermal conductivity of greater than 3 W/m°K.

3. The method of claim 1, wherein the polymer matrix comprises a thermoplastic polymer selected from the group consisting of polycarbonate, polyethylene, polypropylene, acrylics, vinyls, fluorocarbons, polyamides, polyesters, polyphenylene sulfide, and liquid crystal polymers.

4. The method of claim 3, wherein the thermoplastic polymer is polyphenylene sulfide.

5. The method of claim 1, wherein the thermally-conductive, electrically-insulating material is selected from the group consisting of calcium oxide, titanium oxide, silicon oxide, zinc oxide, silicon nitride, aluminum nitride, and boron nitride.

6. The method of claim 1, wherein the composition further comprises a reinforcing material to strengthen the polymer matrix.

7. The method of claim 1, wherein the composition comprises about 30 weight % polyphenylene sulfide, about 60 weight % boron nitride particles, and about 10 weight % reinforcing chopped glass.

8. A thermally-conductive plastic substrate for supporting electronic circuits, comprising i) about 20% to about 80% by weight of a polymer matrix, and ii) about 20% to about 80% by weight of a thermally-conductive, electrically-insulating material;

9. The substrate of claim 8, wherein the substrate has a thermal conductivity of greater than 3 W/m°K.

10. The substrate of claim 8, wherein the composition comprises about 30 weight % polyphenylene sulfide, about 60 weight % boron nitride particles, and about 10 weight % reinforcing chopped glass.
